(19) United States
(12) Patent Application Publication
(10) Pub. No.: US 2017/0293809 A1
(43) Pub. Date: Oct. 12, 2017

(54) DRIVER ASSISTANCE SYSTEM AND METHODS RELATING TO SAME

(71) Applicant: Wal-Mart Stores, Inc., Bentonville, AR (US)

(72) Inventors: John P. Thompson, Bentonville, AR (US); Donald R. High, Noel, MO (US)

(21) Appl. No.: 15/480,744

(22) Filed: Apr. 6, 2017

Related U.S. Application Data
(60) Provisional application No. 62/319,614, filed on Apr. 7, 2016.

(51) Int. Cl. G06K 9/00; G05D 1/00; G07C 5/00; H04B 1/3822; H04M 1/60; B60R 1/00; H04N 5/232

(52) U.S. Cl. CPC G06K 9/00791; B60R 1/00; G05D 1/0044; H04N 5/23206; H04B 1/3822; H04M 1/6091; G07C 5/008; B60R 2300/102; B60R 2300/80

(57) ABSTRACT

In some embodiments, apparatus, systems and methods are disclosed for a driver assistance system having a vehicle data sensor configured to collect vehicle data during vehicle operation, an onboard camera and an onboard microphone located in the vehicle and configured to collect audio and video data of a driver and additional driving condition data, a network interface located in the vehicle and coupled to the vehicle data sensor, the onboard camera and the onboard microphone, the network interface configured to communicate real time data to a remote user at a remote location, and an onboard display in communication with the network interface and located in the vehicle, wherein the display is configured to display a real time video and audio feed of the remote user to the driver in the vehicle. A remote display may also be included.

### CROSS-REFERENCE TO RELATED APPLICATION

This application claims the benefit of U.S. Provisional Application No. 62/319,614, filed Apr. 7, 2016, which is incorporated herein by reference in its entirety.

### TECHNICAL FIELD

This invention relates generally to a driver assistance system and methods relating to same, and more particularly, to a driver assistance system for use in a vehicle.

### BACKGROUND

Some primary objectives of conventional retail stores are to provide consumers with the items they need and to do so efficiently so as to maximize sales. With much of today's commerce relying on the delivery of products via vehicles of some sort, it is thus equally important to ensure that the logistics of moving product by vehicle is handled efficiently to help assist this goal of maximizing sales. For example, todays trucking industry routinely equips trucks with GPS systems so that the trucks location can be monitored and that trucks can be efficiently moved from one place to another to help get product where it needs to go, when it needs to go.

One problem with such GPS systems, however, is that they do not provide the person looking at the GPS data with an all-encompassing picture of the vehicle, the vehicle surroundings and (if applicable) the vehicle driver, which the person reviewing the data could use to further assist in determine what best to do with the vehicle next (e.g., what route to send them on, etc.) and/or how best to control the logistics of an entire fleet or fleets of vehicles needed to deliver products.

Another shortcoming with conventional GPS systems equipped on vehicles such as trucks is that they only allow for limited communication and typically only predetermined data can be relayed back to a logistics office or associate via these systems. In real life, however, situations are ever changing, fluid and often time's things arise without warning and, thus, are not foreseeable, so it is hard to setup GPS systems to allow for communication of all data that may be relevant to the remote logistics office or associate using these types of systems.

In addition, conventional logistics systems are only capable of providing limited automated data or information regarding the vehicle (e.g., that which is thought of in advance and then hooked up to sensors to provide) and do not allow dynamic interaction with the vehicle, vehicle surroundings and/or vehicle driver (again if applicable). To get a more accurate picture of what is actually taking place with the vehicle, its surroundings and/or the driver, it is necessary to disrupt the driver and request this information which can be counterproductive if the goal is to keep things moving without interruption.

### BRIEF DESCRIPTION OF THE DRAWINGS

Disclosed herein are embodiments of graphical user interfaces and systems, apparatus and methods for handling and/or navigating data, and more particularly, to retail store management systems, apparatus and methods and interfaces for same.

This description includes drawings, wherein:

FIG. 1 is a diagram of a driver assistance and/or virtual passenger system in accordance with some embodiments of the invention;

FIG. 2 is a component model for driver assistance systems, apparatus and methods in accordance with aspects of the invention; and

FIG. 3 is a swim lane or workflow/process model for driver assistance systems, apparatus and methods in accordance with some embodiments of the invention.

Elements in the figures are illustrated for simplicity and clarity and have not necessarily been drawn to scale or to include all features, options or attachments. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking and pursuant to various embodiments, systems, apparatus and methods are disclosed for a driver assistance system having a vehicle data sensor configured to collect vehicle data during vehicle operation, an onboard camera and an onboard microphone located in the vehicle and configured to collect audio and video data of a driver and additional driving condition data, a network interface located in the vehicle and coupled to the vehicle data sensor, the onboard camera and the onboard microphone, with the network interface configured to communicate real time data to a remote user at a remote location, and an onboard display in communication with the network interface and located in the vehicle, wherein the display is configured to display a real time video and audio feed of the remote user as a virtual passenger to the driver in the vehicle. In a preferred form, the data provided to the remote location will be displayed on a remote display and the onboard camera will include a three hundred sixty degree) (360° )camera capable of providing images of a surrounding environment three hundred sixty degrees(360° )about a reference point in or on the vehicle (e.g., providing a 360° view inside and/or outside the vehicle, etc.). For example, in one form, the 360° camera comprises a plurality of lenses positioned about the vehicle and focused away from an interior of the vehicle to provide a three hundred sixty degree (360° )image of the surrounding exterior environment of the vehicle. A 360° image is compiled from images taken by the plurality of lenses and seemed together to form a 360° image displayed on the remote display. The system, apparatus and method will also include a remote display for displaying data from the driver assistance system and relating to the vehicle, driver and/or vehicle surroundings. Related methods are also disclosed herein and will be discussed in further detail below.

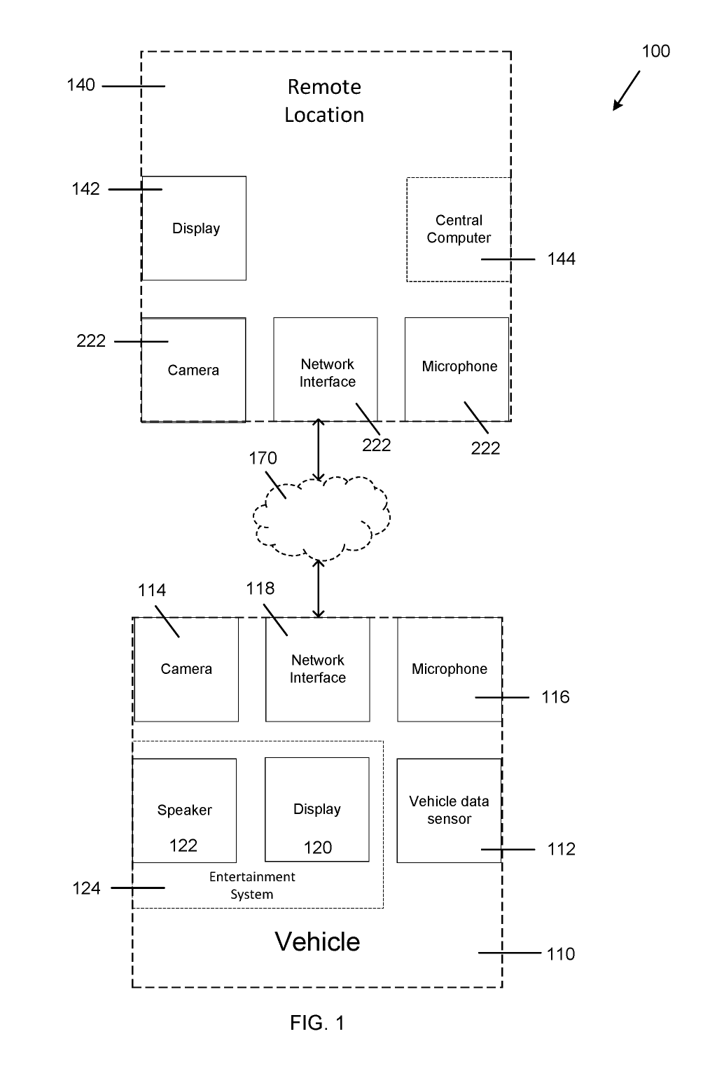

Turning now to FIG. 1, there is illustrated a driver assistance system or apparatus 100 in accordance with some embodiments of the invention. In the form illustrated, the system 100 includes vehicle components located in, on or around/proximate a vehicle 110 and remote components located at a remote location 140 that communicate with one another via a network 170. With respect to the vehicle components, the 100 preferably will include a vehicle data sensor 112 configured to collect vehicle data during vehicle operation, an onboard camera 114 and an onboard microphone 116 located in the vehicle and configured to collect audio and video data pertaining to the vehicle 110, driver and/or additional vehicle data (e.g., additional driving condition data, surrounding environment data, other equipment data such as trailer data, etc.).

The system 100 will further include a network interface 118 located in the vehicle 110 and coupled to the vehicle data sensor 112, the onboard camera 114 and the onboard microphone 116. In a preferred form, the network interface 118 will be configured connect to network 170 and communicate real time data pertaining to the vehicle, driver and/or additional vehicle data to a remote user at a remote location 140. In some embodiments, the vehicle network interface 118 is configured to collate the vehicle data collected by the vehicle data sensor 112 with the audio and video data of the driver of the vehicle 110 and the additional driving condition data observable from the interior of the vehicle 110 collected by the onboard camera 114 and the onboard microphone 116. In some aspects, the vehicle network interface 118 is also configured to stream, in real time, the data collated by the vehicle network interface 118 over the network 170 to a remote display 142 in a remote location 140.

In some aspects, the vehicle network interface 118 collates the aforementioned vehicle data with the audio and video data by overlaying the vehicle data collected by the vehicle data sensor 112 over the video data of the driver of the vehicle 110 and the additional driving condition data collected by the onboard camera 114. In one aspect, the vehicle network interface 118 synchronizes the vehicle data collected by the vehicle data sensor 112 with the video data collected by the onboard camera 114 in order to display the vehicle data overlays in real time relative to the video and/or audio data. In some aspects, the aforementioned vehicle data overlays collated with the video data by the vehicle network interface 118 can be in the form of interactive overlay windows, hot spots, and/or icons, or the like. In other aspects, the vehicle network interface 118 is configured to embed the vehicle data collected by the vehicle data sensor 112 directly into the video data feed collected by the onboard camera 114, for example, by inserting data packets containing the vehicle data collected by the vehicle data sensor 112 into the video data stream generated by the onboard camera 114 to generate a collated data stream.

In some embodiments, the aforementioned overlaying of the video data of the driver of the vehicle 110 and the additional driving condition data with the vehicle data results in the collated data streamed to the remote user at the remote location 140 and appearing on the remote display 142 as real time video data of the driver of the vehicle 110 and the additional driving condition data collected by the onboard camera 114 together with one or more overlays that display vehicle data information collected by one or more vehicle data sensors 112. For example, the vehicle data information that overlays the video data stream can include data relating to the cabin of the vehicle 110, or to the trailer being hauled by the vehicle 110, and can include data including but not limited to: speedometer data (i.e., traveling speed of the vehicle), global positioning system (GPS) data, degrees of freedom data (e.g., surge, heave, sway, pitch, yaw and roll, etc.), load weight, fluid level, fluid temperature, exhaust data, power data, audible data, odor data, temperature data and/or dashboard data, lift gate data.

In some forms, the system 100 will also include an onboard display 120 in communication with the network interface 118 and located in the vehicle 110, with the display 120 being configured to display data, such as a real time video and audio feed of the remote user or from the remote location 140 to the driver in the vehicle 110. This data may be presented is such a way as to make the display 120 and system 100 act as a virtual passenger, or at least some of the in-vehicle or onboard components to act as a virtual passenger.

In a preferred form, the aforementioned collated data provided to the remote user at the remote location 140 will be displayed on a remote display 142. In other words, in some aspects, the remote display 142 of the remote user located at the remote location 140 is configured to receive a video stream from the vehicle network interface 118 that includes the data collated by the vehicle network interface 118, which includes the vehicle data collected by the vehicle data sensor 112, the audio and video data of the driver of the vehicle 110, and the additional driving condition data collected by the onboard camera 114 and the onboard microphone 116. In some aspects, the onboard camera 114 will include a three hundred sixty degree (360° )camera capable of providing images of a surrounding environment three hundred sixty degrees (360° )about a reference point in or on the vehicle (e.g., providing a 360° view inside the vehicle, outside the vehicle and/or both inside and outside the vehicle, etc.). For example, in one form, the 360° camera 114 comprises a plurality of lenses positioned about the vehicle 110 and focused away from an interior of the vehicle to provide a three hundred sixty degree (360° )image of the surrounding exterior environment of the vehicle 110. A 360° image is compiled from images taken by the plurality of lenses and seemed together to form a 360° image displayed on the remote display 142.

The system 100 may also include an onboard speaker, such as speaker module 122, which is in communication with the network interface 118 for communicating audio data from the remote location 140 to the vehicle 110. For example, in some embodiments, the speaker module 122 includes a wireless communication interface for playing the audio data from the remote location 140 over speakers 122 located in the vehicle 110. The wireless communication module may include a Bluetooth (BT) module for linking with an entertainment system 124 of the vehicle and playing the audio from the remote location 140 over the speakers 122 located in the vehicle 110 (e.g., the OEM speakers and audio system of the vehicle itself). The microphone 116 may also have a Bluetooth (BT) wireless communication module for linking with the entertainment system 124 of the vehicle 110 which in turn is connected to the network interface 118 to transmit audio data received from the microphone 116 to the remote location 140. In some vehicles 110, the camera 114, microphone 116 and/or network interface 118 may also be part of the vehicle entertainment system 124.

In some forms, the vehicle data sensor 112 of the system 100 is configured to collect cab characteristic data including one or more of velocity, GPS data, degrees of freedom data (e.g., surge, heave, sway, pitch, yaw and roll, etc.), load, fluid level, fluid temperature, exhaust data, power data, audible data, odor data, temperature data and/or dashboard data. The vehicle data sensor 112 may also (or in the alternative) be configured to collect trailer characteristic data including one or more of velocity, GPS data, degrees of freedom data, load, fluid level, fluid temperature, power data, audible data, odor data, temperature data, and/or lift gate data.

The onboard display 120 utilized in the system, apparatus and/or method may include a tablet computer containing the network interface 118, the onboard camera 114 and onboard microphone 116 in communication with the network interface 118 to communicate with the remote location 140 and has a touch sensitive display for interacting with the tablet computer. In some forms, the tablet computer is removable for use remote from the vehicle (e.g., outside of the cab of the vehicle, in or outside of the trailer, elsewhere away from the vehicle, etc.). The tablet may include a network interface 118 such as a built-in LTE communication module located within the tablet for enabling communication between the tablet computer and the remote location 140. In other forms, the onboard display 120 may be generated from a projector or projection lens to display an image elsewhere (e.g., elsewhere in the vehicle, on an interior surface of the vehicle, under the hood of the vehicle or interior surface of the hood of the vehicle, on an interior surface of the trailer such as an inner wall of the trailer, as a hologram, etc.). In still other forms, the display 120 may be a heads-up display projected on the windshield of the vehicle 110 or may be a display fixedly attached to the dashboard or other part of the vehicle (e.g., such as a built in screen for displaying navigation data, audio or other entertainment data, etc.).

As discussed above, in addition to the in-cab or onboard equipment, the system 100 may include a remote display 142 located at the remote location 140 and connected to the camera 114 via a network 170 and displaying data from the 360° camera 114. In a preferred form, the remote display 142 is a virtual reality display, such as a head mounted device (HMD) (e.g., Oculus Rift virtual reality system or other headsets, Google Glass or other optical head-mounted displays, etc.). In some aspects, remote display 142 and the camera 114 are configured such that movement of the remote display 142 (e.g., HMD) by the remote user at the remote location 140 is translated over the network 170 to the vehicle network interface 118, which in turn sends a signal to the onboard camera 114 that causes the onboard camera 114 to move in correspondence to the movement of the remote display 142 by the remote user. It will be appreciated that, in some configurations, the movement of the remote display 142 does not cause actual movement of the onboard camera 114, but instead causes the onboard camera 114 to transmit to the remote display 142 multiple video data streams obtained via multiple lenses of the onboard camera 114.

With this configuration the system 100 is capable of combining virtual reality equipment with real-time video and/or audio and with real-time semi-tractor and/or trailer data (such as telemetry data, etc.). The remote display 142 is capable of providing three dimensional (3D) augmented reality to allow a remote user to interact with the parts of the machine which are connected by an internal tractor network to enable real-time diagnosis and/or maintenance of issues with the vehicle, real-time information of the driver or their surroundings, increase interactivity between the driver/his or her managers/subordinates/colleagues, increase interactivity with a local tractor and a related business and/or may involve using a projector and/or projection lens to help display a virtual passenger, etc.

While the remote display 142 has focused on HMDs, such as headsets or optical wear, it should be understood that the display 142 could also be any other type of display to visualize the data, such as a desktop computer screen, the screen of a mobile electronic device (e.g., laptop, tablet, smartphone, etc.), or it may include a projector with a projection lens for projecting the data onto a mock-up or model of the vehicle or portions of the vehicle 110. For example, in some forms, a projector may be used to project the image overlaid on a model dashboard of the vehicle, etc. It could alternatively be projected as a 3D hologram allowing the remote party to visualize in 3D the remote part being analyzed from the vehicle 110.

The driver assistance system 100 may also include a central computer system 144 connected to the onboard display 120, the onboard camera 114, the onboard microphone 116 and the remote display 142 for storing and synchronizing data to display same in real-time or time delayed, as desired. In one form, the central computer system 144 includes memory for saving the stored and synchronized data to allow same to be recalled for time delayed viewing to investigate a problem experienced with the vehicle 110 while in operation at an earlier time. In this way, the computer system 144 can be setup or configured to provide real-time data between the vehicle 110 and remote location 140, or time-delayed data between the vehicle 110 and remote location 140. For example, if a truck driver is having problems with his vehicle or load, the computer system 144 can allow the driver and a technician or logistics associate located at the remote location 140 to discuss in real-time the issues with the vehicle or load and fix or troubleshoot the problem together. In other instances, a driver may experience a non-critical problem that they report sometime after the event occurred and the computer system 144 can allow the technician or logistics associate go back to the collected data for the relevant period of time and experience what the driver experienced to research and understand the problem and determine a solution for same. In instances where a table computer or other mobile electronic device is used as an onboard component of the system 100, the driver can take the device out of the cab to offer further data to the remote technician or logistics associate, such as taking the device out of the vehicle to look under the hood at the engine of the vehicle or taking it out of the vehicle to inspect the trailer, vehicle or trailer wheels, etc.

In some forms, the central computer 144 could be a server or database dedicated to the collection of data from the vehicle or its surroundings. The actual components of the computer or database could be physically present in one location or remotely located over different locations, such as cloud based systems and/or systems with remote back-ups, etc. In yet other forms, the computer may be used for additional purposes and simply access a database or server dedicated to the collection of data from the vehicle or its surroundings. It should also be understood that while one remote location 140 has been referenced, thus far, in alternate embodiments the remote location may actually consist of more than one remote location. For example, in some forms, the data provided from the vehicle may be viewed by a logistics associated in a logistics center and be separately viewed (either simultaneously or at different times) by a mechanic or technician at a service center.

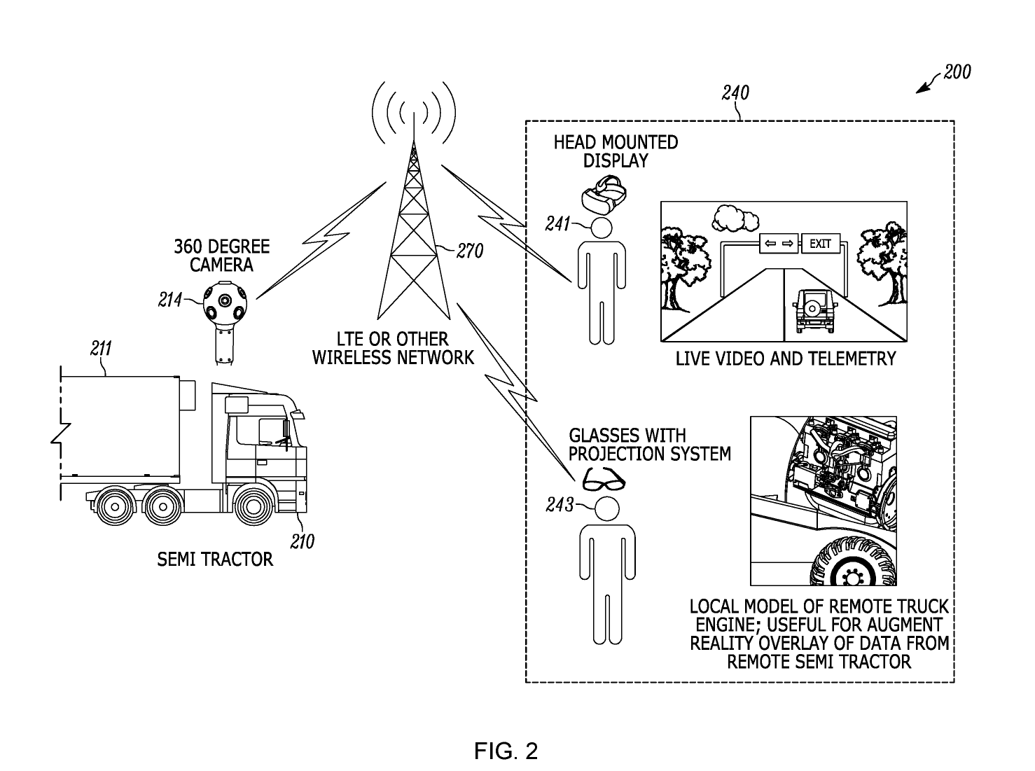

In FIG. 2 a more detailed or specific system or apparatus is illustrated in accordance with aspects of the invention which is referred to generally by reference numeral 200. In this embodiment, items that are similar to those discussed above with respect to FIG. 1 will use similar latter two-digit reference numerals, but be prefixed with “2” instead of “1”. Thus, whereas system 100 included a vehicle 110 connected to a remote location 140 via network 170, system 200 includes a vehicle 210 connected to one or more remote locations 240 via network 270.

In the form illustrated, the vehicle is a semi-tractor 210 and includes a 360° degree camera 214, a 360° microphone system inside the cab of the vehicle 210, and a high speed wireless network 270, such as an LTE or satellite-based network, that records current conditions inside and outside of the vehicle 210. This data is transmitted to a central system located at a remote location 240. In a preferred form, telemetry data from the tractor 210 is transmitted (e.g., velocity, trailer load, engine characteristics such as RPM, fuel and/or fluid levels, coolant temperature, etc.). Additional sensors may be added to the tractor 210 and trailer 211 to track other metrics, such as engine/exhaust odor, external sounds, etc.

In one embodiment, the system 200 is configured to have a remote passenger view on a display, such as headset 241 of HMD, which includes a display screen and headphones and allows the remote passenger to have a real-time view of semi-tractor 210. In a preferred form, the tractor telemetry can be overlaid on the video being displayed on the head mounted display, such as by having the gauges overlaid on a boundary of the image the virtual passenger is viewing (e.g., overlaid along the bottom, side or top of the displayed image, etc.). A maintenance person or associate can also use telemetry in an augmented reality display to overlay real telemetry and movement information over a similar physical model of the remote truck 210 on a local truck if desired. The remote passenger can converse with the vehicle driver via speakers connected to camera/microphone system. If desired, an onboard avatar can be present on the onboard display illustrating an image to symbolize the remote passenger or by using actual video of the remote participant (e.g., such as displaying the image on a tablet within the truck 210). The remote maintenance person can then use the telemetry data to diagnose real-time issues with the tractor 210.

In alternate configurations, the system 200 may be configured to allow the remote passenger to use other forms of displays (either in addition to or in lieu of HMD headset 241). For example, in one form, the system 200 may include optical displays, such as head mounted glasses or eyewear 243. In a preferred form, such eyewear 243 will include an ear piece and microphone to allow the remote passenger (e.g., logistics associate, maintenance personnel, etc.) to communicate with the driver.

In this way, the system 200 is capable of combining virtual reality equipment with real-time video/audio with real-time semi-tractor telemetry data. The system 200 also allows for real-time diagnosis of semi-tractor issues and allows remote users to use 3D augmented reality to interact with the parts of the machine which is connected by an internal tractor network, which can enable maintenance and/or increased interactivity with a local tractor 210. As mentioned above, in some forms, the in-vehicle equipment may also include (either as the display or in addition to another type of display) a projector with a projection lens for projecting an image of the virtual passenger.

In addition to the above-identified embodiments, it should be understood that several methods are also disclosed herein. For example, computer implemented method is disclosed that includes providing onboard vehicle components in a vehicle including a vehicle data sensor, an onboard camera, an onboard microphone, an onboard display and an onboard network interface which connects the onboard vehicle components to a remote display at a remote location operable by a remote user. Then, by a control circuit, collecting audio and video data of a driver and additional driving condition data via the onboard vehicle components. Communicating the audio and video data real-time to the remote user via the remote display located at the remote location, and displaying a real-time video and audio feed of the remote user to the driver in the vehicle to allow interaction between the driver and the remote user.

The method may further include having the remote display comprise a virtual reality display and having the collecting audio and video data of the additional driving condition data step comprise collecting audio and video data of at least one of cab characteristic data and/or trailer characteristic data. In some forms, the virtual reality display is a HMD and the method comprises displaying the audio and video data of the driver and additional driving condition data on the HMD. The onboard vehicle components may include a tablet computer with a touch screen and displaying the real-time video and audio feed of the remote user to the driver may comprise displaying the real-time video and audio feed of the remote user on the touch screen of the tablet computer.

In some forms, the computer implemented method includes providing a central computer system connected to the onboard vehicle components and the remote display, and storing the audio and video data of the driver and additional driving condition data via the central computer system to allow same to be recalled for time delayed viewing to investigate a problem experienced with the driver or vehicle while in operation at an earlier time.

It should be understood that other methods are also disclosed herein, such as methods for providing remote diagnostics of a vehicle, and providing real-time status of a vehicle, vehicle load or vehicle surroundings. Other methods include methods for displaying remote vehicle data (e.g., telemetry data, etc.), and methods for tracking, capturing and/or analyzing such data.

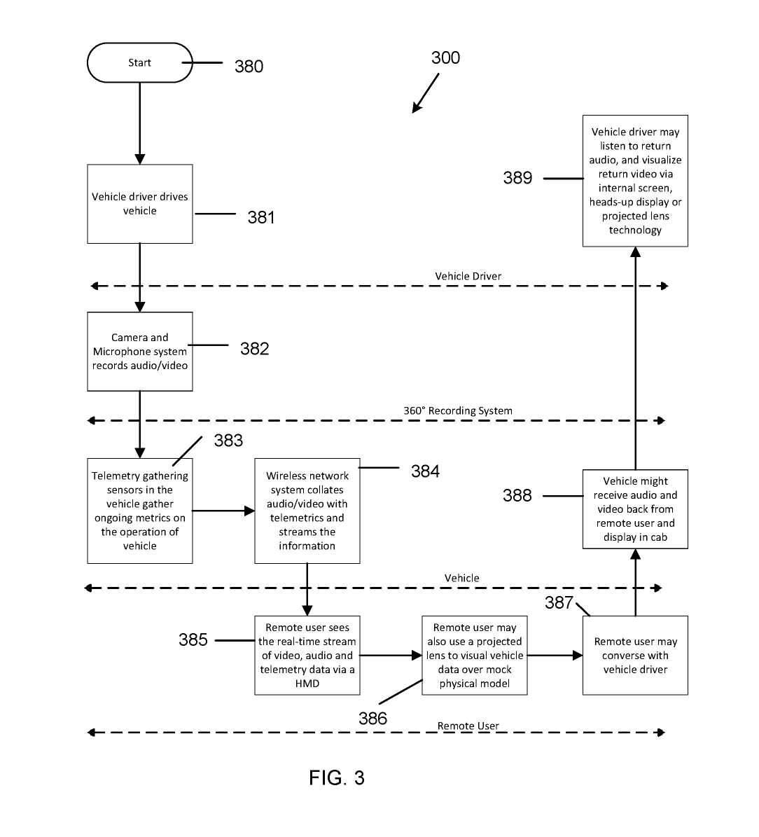

A workflow or process model (e.g., swim lane) for a driver assistance systems in accordance with the invention is illustrated in FIG. 3 and is referred to generally by reference numeral 300. The lanes of the model are broken out by function or functional aspect of the model 300 including acts performed by the vehicle driver, the 360° recording system, the vehicle and the remote user. The model begins at step 380 and with the vehicle driver driving the vehicle in step 381. While the driver is driving, the camera and microphone of the 360° recording system records audio and/or video in step 382 and telemetry gathering sensors in the vehicle gather ongoing metrics on the operation of the vehicle in step 383. The wireless system collates the audio/video data with telemetrics and streams the information in step 384.

As discussed above, in some embodiments, the wireless system (e.g., vehicle network interface 118) collates the telemetry with the audio and/or video data by overlaying the telemetry collected by the vehicle data sensor 112 over the video data collected by the onboard camera 114, and in some aspects, synchronizes the telemetry data collected by the vehicle data sensor 112 with the video data collected by the onboard camera 114 in order to display the telemetry overlays to the remote user in the remote location 140 in real time.

The remote user sees the real-time stream of video/audio and telemetry data via a HMD in step 385 and in step 386 the remote user may use a projector with projection lens to project the data over a mock digital or physical model of the vehicle or vehicle components (e.g., engine, dashboard, trailer, etc.). In step 387 the remote user may also converse with the vehicle driver. The system 300 may also be setup to have the vehicle receive audio and/or video back from the remote user and display this data in the vehicle or wherever the onboard display is located at the time the data is transmitted as illustrated in step 388. Lastly, in step 389 the vehicle driver may listen to the return audio or visualize the return video via the onboard display or in-vehicle display of system 300. This onboard display may be an internal screen fixedly mounted within the vehicle or may be a screen on a movable electronic device that can be stored within the vehicle, but moved about the vehicle or taken with the driver when leaving the vehicle. In other forms, the onboard display may be a heads-up display projected on the windshield of the vehicle or be a projector capable of projecting an image of the data (e.g., projecting on a surface, projecting as a hologram, etc.).

Thus, it has been shown that a need exists for improved systems, apparatus and methods for a driver assistance system and methods relating to same, and in particular, a driver assistance system for use in a vehicle to serve as a virtual passenger and allow real-time observations and actions to be taken by logistics associates, and methods relating to same. The above disclosure provides answers to this need. Further, those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept. It should also be understood that while certain features have been described with a specific embodiment, features of different embodiments may be combined with one another to form yet other embodiments as desired.

What is claimed is:

1. A driver assistance system for use in a vehicle comprising:
at least one vehicle data sensor configured to collect vehicle data during vehicle operation;
an onboard camera and an onboard microphone located in the vehicle and configured to collect audio and video data of a driver of the vehicle and additional driving condition data observable from an interior of the vehicle;
a vehicle network interface located in the vehicle and coupled to the vehicle data sensor, the onboard camera, and the onboard microphone, the vehicle network interface configured to collate the vehicle data collected by the at least one vehicle data sensor with the audio and video data of the driver of the vehicle and the additional driving condition data observable from the interior of the vehicle collected by the onboard camera and the onboard microphone, and to stream, in real time, data collated by the vehicle network interface over a network to a remote user at a remote location;
an onboard display in communication with the vehicle network interface and located in the vehicle, wherein the onboard display is configured to display a real time video and audio feed of the remote user to the driver in the vehicle; and
a remote display of the remote user located at the remote location in communication with the vehicle network interface, the remote display configured to display, to the remote user at the remote location, a video stream comprising the data collated by the vehicle network interface and including the vehicle data collected by the at least one vehicle data sensor, the audio and video data of the driver of the vehicle, and the additional driving condition data observable from the interior of the vehicle collected by the onboard camera and the onboard microphone.

2. The driver assistance system of claim 1 wherein the onboard camera is a three hundred sixty degree (360° ) camera capable of providing images of a surrounding environment three hundred sixty degrees (360° ) about a reference point in or on the vehicle.

3. The driver assistance system of claim 2 wherein the 360° camera comprises a plurality of lenses positioned about the vehicle and focused away from an interior of the vehicle to provide a three hundred sixty degree (360° ) image of the surrounding exterior environment of the vehicle.

4. The driver assistance system of claim 3 wherein the 360° image is compiled from images taken by the plurality of lenses and seemed together to form the 360° image.

5. The driver assistance system of claim 1 further comprising an onboard speaker module in communication with the vehicle network interface for communicating audio data from the remote location to the vehicle.

6. The driver assistance system of claim 5 wherein the speaker module includes a wireless communication interface for playing the audio data from the remote location over speakers located in the vehicle.

7. The driver assistance system of claim 6 wherein the wireless communication module is a Bluetooth (BT) module for linking with an entertainment system of the vehicle and playing the audio from the remote location over the speakers located in the vehicle.

8. The driver assistance system of claim 2 wherein the microphone has a Bluetooth (BT) wireless communication module for linking with an entertainment system of the vehicle and the entertainment system of the vehicle being connected to the vehicle network interface to transmit audio data received from the microphone to the remote location.

9. The driver assistance of claim 1 wherein the vehicle data collected by the at least one vehicle data sensorcomprises cab characteristic data including one or more of: velocity, GPS data, degrees of freedom data, load, fluid level, fluid temperature, exhaust data, power data, audible data, odor data, temperature data, and dashboard data.

10. The driver assistance of claim 1 wherein the vehicle data collected by the at least one vehicle data sensorcomprises trailer characteristic data including one or more of: velocity, GPS data, degrees of freedom data, load, fluid level, fluid temperature, power data, audible data, odor data, temperature data, and/or lift gate data.

11. The driver assistance system of claim 1 wherein the onboard display comprises a tablet computer containing the network interface, the onboard camera and onboard microphone in communication with the network interface to communicate with a remote location and has a touch sensitive display for interacting with the tablet computer.

12. The driver assistance system of claim 11 wherein the tablet computer is removable for use remote from the vehicle and the network interface comprises a built-in LTE communication module located within the tablet for enabling communication between the tablet computer and the remote location.

13. The driver assistance system of claim 1 further comprising a remote display located at the remote location and connected to the camera via a network and displaying data from the camera.

14. The driver assistance system of claim 1 wherein the remote display is a virtual reality display, wherein movement of the virtual reality display by the remote user at the remote location causes a corresponding movement of the onboard camera in the vehicle.

15. The driver assistance system of claim 14 wherein the virtual reality display is a head mounted device (HMD), wherein movement of the HMD by the remote user at the remote location causes a corresponding movement of the onboard camera in the vehicle.

16. The driver assistance system of claim 1 further comprising a central computer system connected to the onboard display, the onboard camera, the onboard microphone and the remote display for storing and synchronizing data to display same in real-time or time delayed.

17. The driver assistance system of claim 16 wherein the central computer system includes memory for saving the stored and synchronized data to allow same to be recalled for time delayed viewing to investigate a problem experienced with the vehicle while in operation at an earlier time.

18. The driver assistance system of claim 1 further comprising a projector configured to project an image of at least a portion of the vehicle as a display, the image of the at least a portion of the vehicle including at least a portion of the data collated by the vehicle network interface.

19. A computer implemented method comprising:
providing onboard vehicle components in a vehicle including at least one vehicle data sensor, an onboard camera, an onboard microphone, an onboard display, and an onboard vehicle network interface configured to stream, in real time, data collected by at least one of the onboard vehicle components to a remote user at a remote location;
collecting, via the onboard microphone and via the onboard camera, the audio data and the video data of the driver of the vehicle and the additional driving condition data observable from an interior of the vehicle;
collecting, via the at least one vehicle data sensor, vehicle data during vehicle operation;
collating, via the vehicle network interface, the vehicle data collected by the at least one vehicle data sensor with the audio data and the video data of the driver of the vehicle and the additional driving condition data observable from the interior of the vehicle collected by the onboard camera and the onboard microphone;
streaming, in real time, the data collated by the vehicle network interface over a network to the remote user at the remote location; and
providing the remote user at the remote location with a remote display in communication with the vehicle network interface;
displaying, via the remote display and to the remote user at the remote location, a video stream comprising the data collated by the vehicle network interface and including the vehicle data collected by the at least one vehicle data sensor, the audio and video data of the driver of the vehicle, and the additional driving condition data observable from the interior of the vehicle collected by the onboard camera and the onboard microphone.

20. The method of claim 19 wherein the remote display comprises a virtual reality display, and further comprising moving the onboard camera in the vehicle in response to movement of the virtual reality display by the remote user at the remote location.

21. The method of claim 20 wherein the virtual reality display is a head mounted device (HMD), and further comprising displaying the data collated by the vehicle network interface on the HMD, and wherein the providing of the onboard vehicle components further comprises providing a tablet computer with a touch screen, and displaying a real-time video and audio feed of the remote user to the driver of the vehicle on the touch screen of the tablet computer.

22. The method of claim 20 further comprising:
providing a central computer system connected to the onboard vehicle components and the remote display; and
storing, via the central computer system, the vehicle data collected by the at least one vehicle data sensor and storing the audio and video data of the driver of the vehicle and additional driving condition data observable from the interior of the vehicle collected by the onboard camera and the onboard microphone; and
permitting the stored vehicle data and the audio and video data of the driver and the additional driving condition data to be recalled for time delayed viewing to investigate a problem experienced with the driver or vehicle while in operation at an earlier time.

23. The method of claim 20 further comprising:
providing a projector for projecting an image of at least a portion of the vehicle as a display, the image of the at least a portion of the vehicle including at least a portion of the data collated by the vehicle network interface; and
wherein the displaying step further comprises projecting the data collated by the vehicle network interface from the projector to assist the remote user at the remote location in interacting with the driver of the vehicle.
